(19) United States
(12) Patent Application Publication
(10) Pub. No.: US 2008/0103019 A1
(43) Pub. Date: May 1, 2008

(54) Operator interface for torque controlled transmission

(75) Inventors: Michael G. Cronin, Peoria, IL (US); Frank A. Demarco, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/589,750

(22) Filed: Oct. 31, 2006

(51) Int. Cl. F16H 61/662

(52) U.S. Cl. 477/46

(57) ABSTRACT

A continuously variable transmission for a machine is disclosed. The machine may have a driven element, a first operator input device, a second operator input device, and a controller. The controller may be configured to receive a first displacement signal associated with the first operator input device, and a second displacement signal associated with the second operator input device. The controller may be further configured to determine a net operator input value as a function of the first and second displacement signals, and regulate an output of the driven element in response to the determined net operator input value.

### TECHNICAL FIELD

The present disclosure is directed to a transmission operator interface and, more particularly, to an operator interface for use with a torque control transmission.

### BACKGROUND

Machines such as, for example, wheel loaders, dozers, and other heavy equipment are used to perform many tasks. To effectively perform these tasks, the machines require an engine that provides significant torque through a transmission to one or more ground engaging devices. In order to control the speed and torque output of the ground engaging devices, the operator of these machines is typically provided with three different foot pedals. One of the three pedals is actuated to affect engine fueling. Another of the three pedals is actuated to affect vehicle braking. The third of the three pedals is actuated to disengage the engine from the transmission and, if depressed enough, also affects vehicle braking.

Although this configuration may be suitable when a mechanical, step-change transmission is utilized to transmit power from the engine to the ground engaging devices, it may be insufficient when a continuously variable transmission (CVT) is utilized. A CVT is an automatic type of transmission that provides an infinite number of output ratios within its ratio range. For example, a hydraulic CVT includes a pump and a fluid motor that receives pressurized fluid from the pump. Depending on a discharge flow rate and pressure of the pump, the motor speed and output torque at the ground engaging device may be varied. An electric CVT includes a generator and an electric motor that receives current from the generator. Depending on the current supplied to the motor, the motor speed and output torque may be varied. When using a CVT, the goal is to keep the engine as efficiently stable as possible. In this situation, the strategy described above of changing engine fueling and/or disconnecting the engine from the transmission may work against the efficiency goal. Therefore, an alternative strategy is required to efficiently control operation of a machine utilizing a CVT.

One alternative method of machine control is described in U.S. Patent Publication No. 2005/0103555 (the '555 publication) by Cannon et al., published on May 19, 2005. The '555 publication describes an operator interface for a machine having a hydraulic CVT. Specifically, the operator interface is described as having an acceleration foot pedal, a deceleration foot pedal, and a brake. Each of the acceleration and deceleration foot pedals are movable away from a neutral position, and the actuation degree of these pedals is measured by a first and second displacement sensor, respectively. The deceleration pedal is coupled to the brake such that the brake is actuated toward an end of travel of the deceleration pedal away from its neutral position.

An electronic control module (ECM), described in the '555 publication, communicates with the first and second displacement sensors to control the machine's velocity aspects in response thereto. For example, a target velocity is defined by the instantaneous positions of the acceleration and deceleration pedals, and the ECM directs the machine to accelerate or decelerate at a pre-determined rate corresponding to the target velocity. As described above, in a CVT application, the speed of the engine is typically held constant. Thus, to achieve the required acceleration or deceleration, operation of the CVT must, instead, be controllably varied. In one example, the ECM is operable, based on pedal position, to change the angle of a swash plate within a transmission pump, to vary the flow of oil through a pump and motor combination and, thereby, achieve the required acceleration or deceleration.

Although the system of the '555 publication may provide efficient regulation of a speed-controlled hydraulic CVT, it may do little for an electric CVT or any type of CVT that is torque controlled. A torque controlled CVT provides many benefits over a speed-controlled CVT such as, for example, limited drawbar pull while in a pile and prevention of pile climbing.

The operator interface of the present disclosure solves one or more of the problems set forth above.

### SUMMARY OF THE INVENTION

One aspect of the present disclosure is directed to a continuously variable transmission. The continuously variable transmission may include a driven element, a first operator input device a second operator input device, and a controller. The controller may be configured to receive a first displacement signal associated with the first operator input device, and a second displacement signal associated with the second operator input device. The controller may be further configured to determine a net operator input value as a function of the first and second displacement signals, and regulate an output of the driven element in response to the determined net operator input value.

Another aspect of the present disclosure is directed to another continuously variable transmission. This continuously variable transmission may include a driven element, an operator input device, and a controller. The controller may be configured to receive a displacement signal associated with the operator input device, determine a desired output of the driven element, and determine an actual output of the driven element. The controller may be further configured to directly regulate a torque output of the driven element in response to the displacement signal, the desired output, and the actual output.

In yet another aspect, the present disclosure is directed to a method of transmitting power from an engine to a traction device. The method may include receiving a first indication of a desired acceleration, receiving a second indication of a desired deceleration, and determining a net indication value based on the first and second indications. The method may also include directly controlling a torque directed to the traction device in response to the net indication value.

### BRIEF DESCRIPTION OF THE DRAWINGS

FIG. 1 is a diagrammatic illustration of an exemplary disclosed machine;

FIG. 2 is a pictorial illustration of an exemplary disclosed operator station for use with the machine of FIG. 1;

FIG. 3 is a diagrammatic illustration of an exemplary disclosed control system for use with the operator station of FIG. 2;

FIG. 4 is an exemplary disclosed control map for use with the control system of FIG. 3;

FIG. 5 is another exemplary disclosed control map for use with the control system of FIG. 3;

FIG. 6 is another exemplary disclosed control map for use with the control system of FIG. 3; and

FIG. 7 is a flowchart depicting an exemplary method of operating the control system of FIG. 3.

### DETAILED DESCRIPTION

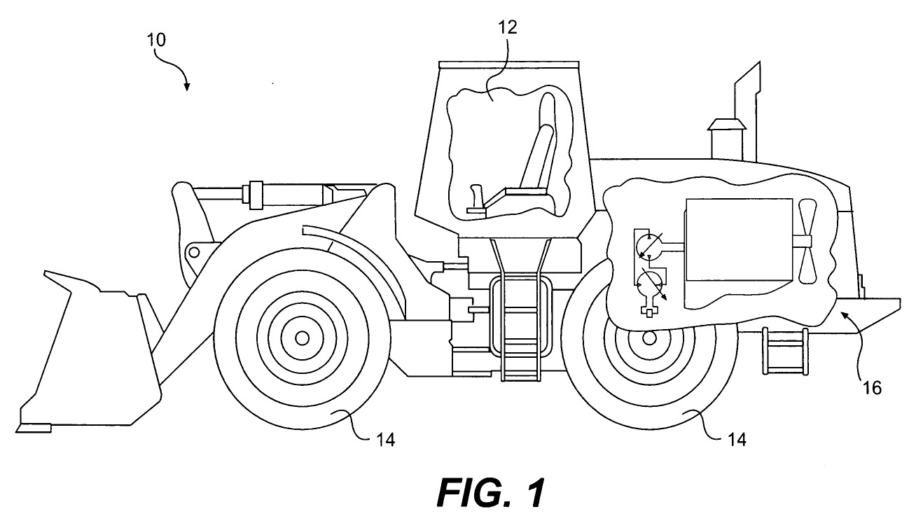

FIG. 1 illustrates an exemplary machine 10 having multiple systems and components that cooperate to accomplish a task. The tasks performed by machine 10 may be associated with a particular industry such as mining, construction, farming, transportation, power generation, or any other industry known in the art. For example, machine 10 may embody a mobile machine such as the wheel loader depicted in FIG. 1, a bus, an on- or off-highway haul truck, or any other type of mobile machine known in the art. Machine 10 may include an operator station 12, one or more traction devices 14, and a power train 16 operatively connected to drive at least one of traction devices 14.

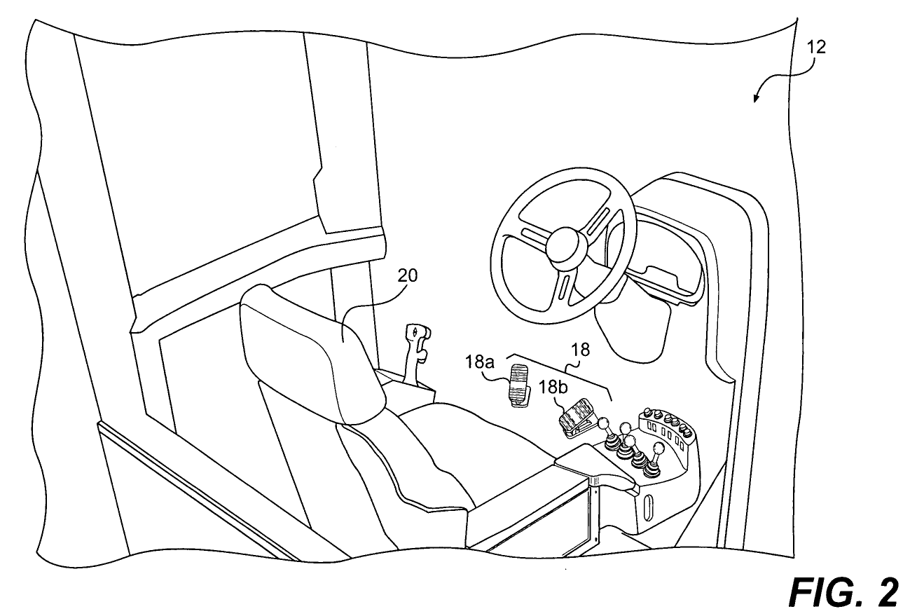

As illustrated in FIG. 2, operator station 12 may include devices that receive input from a machine operator indicative of a desired machine travel maneuver. Specifically, operator station 12 may include one or more operator interface devices 18 located proximate an operator seat 20. Operator interface devices 18 may initiate movement of machine 10 by producing displacement signals that are indicative of a desired machine maneuver. In one embodiment, operator interface devices 18 may include a left foot pedal 18a and a right foot pedal 18b. As an operator manipulates left foot pedal 18a and/or right foot pedal 18b (i.e., displaces left and/or right foot pedals 18a, 18b away from a neutral position), the operator may expect and affect a corresponding machine travel movement. It is contemplated that operator interface devices other than foot pedals such as, for example, joysticks, levers, switches, knobs, wheels, and other devices known in the art, may additionally or alternatively be provided within operator station 12 for travel control of machine 10, if desired.

Traction devices 14 (referring to FIG. 1) may embody wheels located on each side of machine 10 (only one side shown). Alternatively, traction devices 14 may include tracks, belts or other known traction devices. It is contemplated that any combination of the wheels on machine 10 may be driven and/or steered.

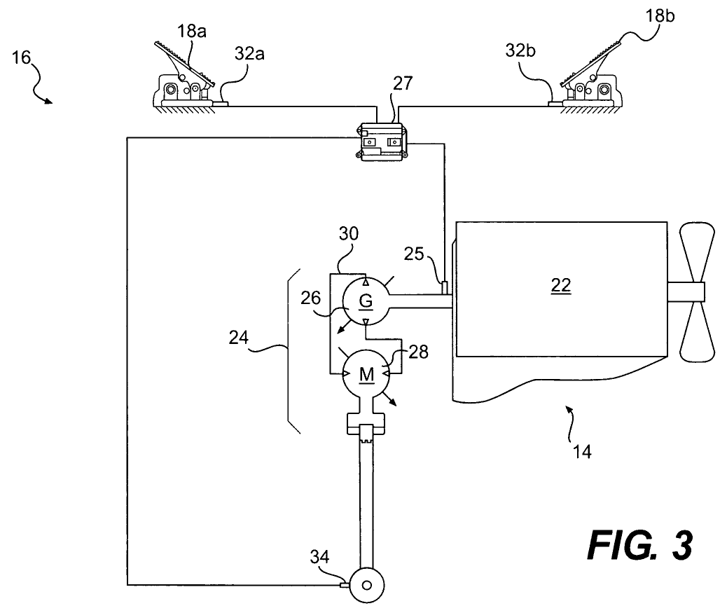

As illustrated in FIG. 3, power train 16 may be an integral package configured to generate and transmit power to traction devices 14. In particular, power train 16 may include a power source 22 operable to generate a power output, a transmission unit 24 connected to receive the power output and transmit the power output in a useful manner to traction devices 14 (referring to FIG. 1), and a control module 27 configured to regulate the operation of transmission unit 24 in response to one or more input.

Power source 22 may include an internal combustion engine having multiple subsystems that cooperate to produce mechanical or electrical power output. For the purposes of this disclosure, power source 22 is depicted and described as a four-stroke diesel engine. One skilled in the art will recognize, however, that power source 22 may be any other type of internal combustion engine such as, for example, a gasoline or a gaseous fuel-powered engine. The subsystems included within power source 22 may include, for example, a fuel system, an air induction system, an exhaust system, a lubrication system, a cooling system, or any other appropriate system.

A sensor 25 may be associated with power source 22 to sense an output speed thereof. In one example, sensor 25 may embody a magnetic pickup type of sensor associated with a magnet embedded within a rotational component of power train 16 such as a crankshaft or flywheel. During operation of power source 22, sensor 25 may sense the rotating magnetic field produced by the magnet and generate a signal corresponding to the rotational speed of power source 22.

Transmission unit 24 may embody, for example, a continuously variable transmission (CVT). Transmission unit 24 may be any type of continuously variable transmission such as, for example, a hydraulic CVT, a hydro-mechanical CVT, an electric CVT, or other configuration as would be apparent to one skilled in the art.

A continuously variable transmission generally consists of a driving element 26 and a driven element 28. In the exemplary electric CVT of FIG. 3, driving element 26 is a generator, such as a three-phase permanent magnet alternating field-type generator, and driven element 28 is an electric motor, such as permanent magnet alternating field-type motor configured to receive power from driving element 26. The generator of driving element 26 may be connected to drive the motor of driven element 28 with electric current via power electronics 30 in response to a torque command directed to driven element 28. In some situations, the motor of driven element 28 may alternatively drive the generator of driving element 26 in reverse direction via power electronics 30.

Power electronics 30 may include generator associated components and motor associated components. For example, power electronics 30 may include one or more drive inverters (not shown) configured to invert three-phase alternating power to direct phase power and vice versa. The drive inverters may have various electrical elements including insulated gate bipolar transistors (IGBTs), microprocessors, capacitors, memory storage devices, and any other similar elements used for operating driving element 26 and driven element 28. Other components that may be associated with the drive inverter include power supply circuitry, signal conditioning circuitry, and solenoid driver circuitry, among others. In addition, power electronics 30 may include a generator heat sink (not shown), and a motor heat sink (not shown) in communication with driving and driven elements 26, 28, respectively. Each heat sink may absorb heat from their respective components of power electronics 30 and transfer this heat to a cooling system (not shown).

Transmission unit 24 may be at least partially controlled with left and right foot pedals 18a, 18b. That is, as left and right foot pedals 18a, 18b are manipulated by an operator, the foot pedals may provide electric signals signifying a desired machine torque output and desired machine speed limit. For example, left and right foot pedals 18a, 18b may have a minimum position and be movable through a range of positions to a maximum position. A sensor 32a, 32b, such as a switch or potentiometer, may be provided in association with each of left and right foot pedals 18a, 18b, respectively, to sense the displacement positions thereof and produce corresponding signals responsive to the displaced positions. The displacement signals from each of sensors 32a and 32b may be directed through control module 27 to transmission unit 24 to control the torque output of driven element 28.

A sensor 34 may be associated with transmission unit 24 and/or traction device 14 (referring to FIG. 1) to sense a travel speed of machine 10. In one example, sensor 34 may embody a magnetic pickup type of sensor associated with a magnet embedded within a rotational component of power train 16 such as a transmission output shaft. During operation of machine 10, sensor 34 may sense the rotating magnetic field produced by the magnet and generate a signal corresponding to the rotational speed of transmission unit 24 and/or the corresponding travel speed of machine 10.

Control module 27 may embody a single microprocessor or multiple microprocessors that include a means for controlling the operation of power train 16 in response to the received signals. Numerous commercially available microprocessors can be configured to perform the functions of control module 27. It should be appreciated that control module 27 could readily embody a general machine microprocessor capable of controlling numerous machine functions. Control module 27 may include a memory, a secondary storage device, a processor, and any other components for running an application. Various other circuits may be associated with control module 27 such as power supply circuitry, signal conditioning circuitry, solenoid driver circuitry, and other types of circuitry.

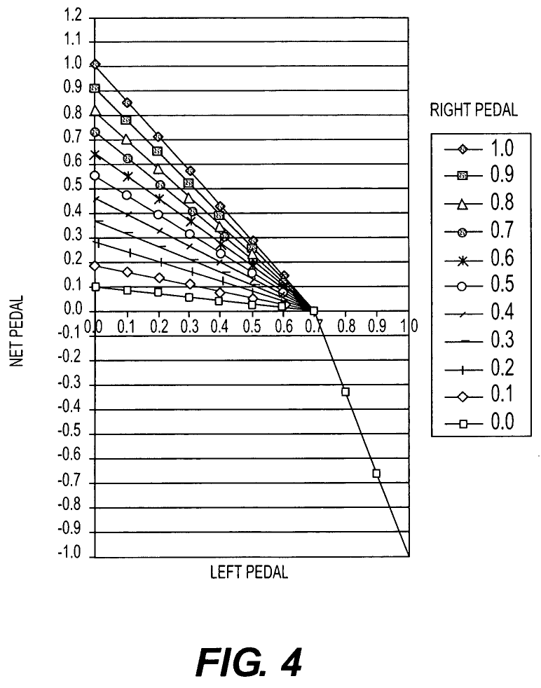

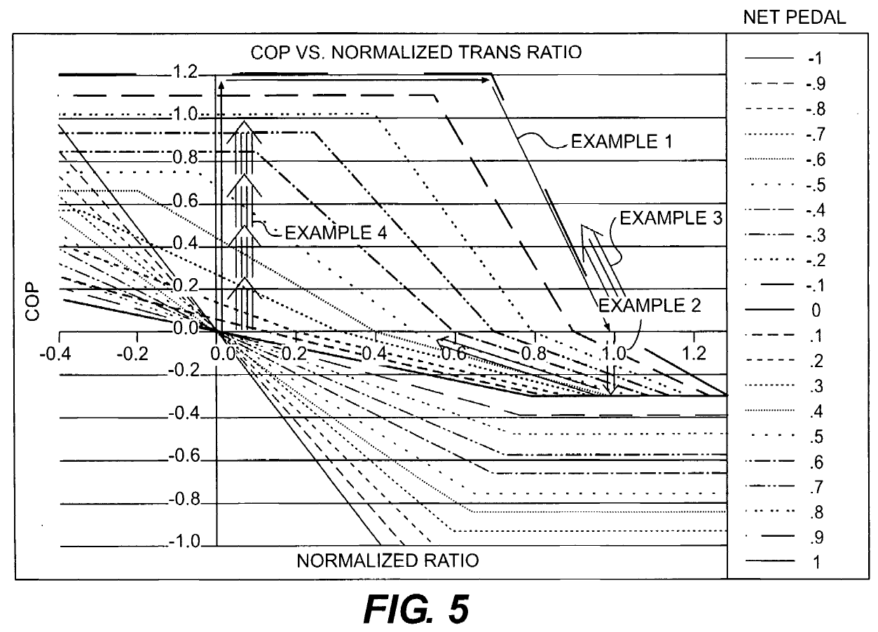

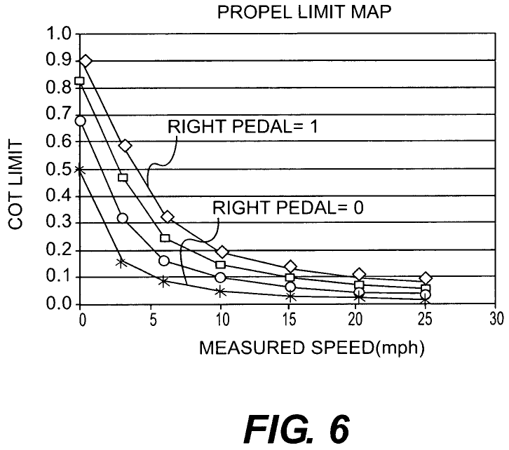

One or more transmission control maps relating the left pedal displacement, right pedal displacement, current travel speed, desired travel speed, torque output command, and torque output limits may be stored within the memory of control module 27. Each of these maps may be in the form of tables, graphs, and/or equations and include a compilation of data collected from lab and/or field operation of power train 16. In one exemplary map illustrated in FIG. 4, the left pedal displacement may form one coordinate axis of a 2-D map that, together with various right pedal displacement curves, may be used to determine a Net Pedal value. In another exemplary map illustrated in FIG. 5, a Normalized Ratio value (actual transmission output ratio/desired transmission output ratio) may form one coordinate axis of a 2-D map that, together with various Net Pedal curves, may be used to determine a Coefficient of Power (COP) value. In yet another exemplary map illustrated in FIG. 6, a measured travel speed of machine 10 may form one coordinate axis of a 2-D map that, together with various Right Pedal Value curves, may be used to limit a final Coefficient of Torque (COT) value utilized to command a torque of driven element 28. It is contemplated that two or more of these maps may alternatively be combined into a single 3-D map, if desired. Control module 27 may reference these maps and control the operation of transmission unit 24 to bring the operation of power train 16 in line with the operator expected or desired performance of machine 10. FIGS. 4-6 will be discussed further in the following section to better illustrate the disclosed system and its operation.

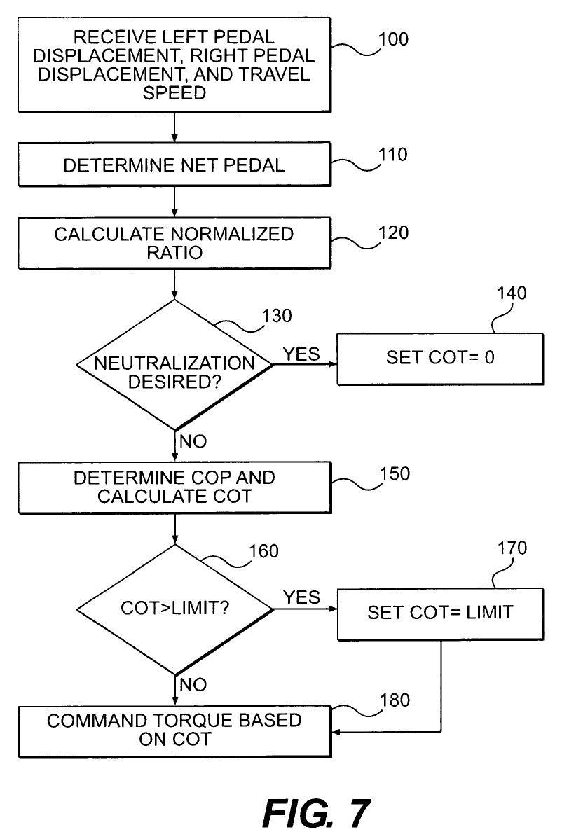

FIG. 7 is a flow chart depicting an exemplary method of controlling the output of transmission unit 24 in response to an operator's input received via left and right foot pedals 18a, 18b. FIG. 7 will also be discussed further in the following section to better illustrate the disclosed system and its operation.

### INDUSTRIAL APPLICABILITY

The disclosed operator interface may be applicable to any vehicle having a torque controlled CVT. In particular, by regulating the torque output of a machine's power train, operator control of the machine may be improved while providing better overall vehicle efficiency. This transmission torque output control may be provided via left and right foot pedals as will be described below.

As illustrated in the flowchart of FIG. 7, the first step in controlling transmission unit 24 may include receiving a plurality of input. Specifically, the displacement of left foot pedal 18a may be received by control module 27 via sensor 32a, the displacement of right foot pedal 18b may be received via sensor 32b, the output speed of power source 22 may be received via sensor 25, and the output speed of transmission unit 24 may be received via sensor 34 (Step I 00).

From the displacement signals of left and right pedals 18a, 18b, control module 27 may determine the Net Pedal value (Step 110). That is, upon receiving the displacement signals from sensors 32a and 32b, control module 27 may reference the control map of FIG. 4 and select a corresponding Net Pedal value. For example, if an operator of machine 10 depressed right pedal 18b about 70% of the distance from the neutral position toward the maximum position of right pedal 18b, and depressed left pedal 18a about 30% of the distance from the neutral position toward the maximum position of left pedal 18a, the right and left pedal values would be approximately 0.7 and 0.3, respectively. Following the right pedal curve corresponding to 0.7 to the intersection with 0.3 along the horizontal axis of the FIG. 4 control map, the Net Pedal value can be taken from the vertical axis as 0.4. Although linear in this example, the relationship between left pedal, right pedal, and Net Pedal values may alternatively be non-linear, if desired.

Following or simultaneous to step 110, control module 27 may calculate a Normalized Ratio value (Step 120). The Normalized Ratio value may be determined according to Eq. 1 below.

$$Normalized Ratio = \frac{Actual Output Ratio}{Desired Output Ratio Limit} \qquad Eq . 1$$

wherein:
   Actual Output Ratio is the ratio of power source output speed to transmission output speed; and
   Desired Output Ratio Limit is the maximum transmission output ratio allowed for a given operator selected gear range (i.e., 1^{st} gear, 2^{nd} gear, 3^{rd} gear, etc.)

For example, if the rotational output speed of power source 22, as measured by sensor 25 is 1200 rpm, the rotational output speed of transmission unit 24, as measured by sensor 34 is 400 rpm, the Actual Output Ratio would be 0.33. If the Desired Output Ratio Limit for the currently selected gear is 1.65, then the Normalized Ratio would be 0.33/1.65 or 0.2.

Following or simultaneous to steps 110 and 120, control module 27 may determine if neutralizing of transmission unit 24 is desired (Step 130). The neutralization desire may be indicated in a number of different ways such as, for example, by the operator setting a parking brake, by the operator selecting a neutral condition (i.e., Park, Neutral, Drive) of the transmission, by the operator fully depressing left foot pedal 18a to its maximum position, in response to a travel speed of machine 10, or in any other manner known in the art. If control module 27 has determined that neutralization of transmission unit 24 is desired, the COT value used to command operation of driven element 28 may be set to zero (Step 140). In this manner, driven element 28 may be prevented from transmitting substantial torque to traction devices 14.

However, if control module 27 has determined that neutralizing is undesired, control module 27 may then determine the COP value and calculate therefrom the COT value (Step 150). The COP value may be representative of a percent of maximum power source output power and can be determined by referencing the control map of FIG. 5. Specifically, FIG. 5 may include multiple curves, each curve representing a specific Net Pedal value. Continuing with the example from above and following the Net Pedal value curve corresponding to 0.4 to the intersection with the Normalized Ratio of 0.2 along the horizontal axis of the FIG. 5 control map, the COP value can be taken from the vertical axis as 0.2 or 20% of a maximum available power from power source 22.

Once the COP value has been determined, a corresponding COT value may be calculated and compared to a COT limit. In particular, the COT value may be calculated as a function of COP, machine mass, and machine travel speed. Once the COT valve has been calculated, it may then be compared to the control map of FIG. 6 to determine if the calculated COT value exceeds a predefined COT limit (Step 160). Continuing with the example from above where the right pedal value is 0.7, control module 27 may find the intersection of the 0.7 right pedal curve with a measured travel speed of machine 10, for example 10 mph, along the horizontal axis, and determine a COT limit of about 0.15.

If the calculated COT value is greater than the COT limit determined in step 160, the COT value may be reset to the COT limit (Step 170) and a torque output command corresponding to the reset COT value may be sent to driven element 28 (Step 180). Otherwise, the COT value may remain unchanged and commanded of driven element 28. The torque output command may be calculated as a function of the COT value, a rated power output of machine 10, and a current travel speed of machine 10.

A first example of dynamically changing the torque command during machine operation will now be given to more fully describe the function of transmission unit 24 and control module 27. Assume a machine operator desires machine 10 to move from a stopped condition and, thus, fully releases left pedal 18a and fully depresses right pedal 18b. With reference to the control map of FIG. 5, this condition would correspond with control following the Net Pedal 1 curve from the (0,0) coordinate location to the (1.2,0) coordinate location. In other words, the COP value and, subsequently, the torque output commanded of driven element 28 may initially be zero and, in response to the full depression of right pedal 18b, the COP value may jump to 1.2 at a controlled rate that may be selectively varied in response to one or more parameters. As can be seen from the control map of FIG. 6, at zero miles per hour and right pedal of one, the COT value may be limited to 0.9.

As the travel speed of machine 10 increases due to the torque output command corresponding to a COT of 0.9 being sent to driven element 28, the Normalized Ratio may likewise increase, and control may follow the Net Pedal 1 curve of FIG. 5 in a positive horizontal direction at the COP=1.2 vertical position. As can be seen from the control map of FIG. 6, the COT limit may decrease in proportion to the increasing travel speed of machine 10, such that less torque is commanded of driven element 28 at higher speeds. Similarly, as the Normalized Ratio exceeds about 0.7, the COP also begins a linearly reducing slope from the 1.2 value to zero at a Normalized Ratio of 1. In other words, once the Actual Output Ratio reaches the Desired Output Ratio Limit, the torque commanded of driven element 28 may be reduced to zero. The shape and degree of this reducing slope may be changed depending on the type of machine, the application of machine 10, and/or operator preference such that the performance of machine 10 is efficient, comfortable, and predictable.

In a second example, assume that machine 10 is traveling at the previously desired speed (i.e., Normalized Ratio=1) and wants to slow down. To slow down, the operator may depress left pedal 18a. With reference to FIG. 5, the Net Pedal value may change to 0.6 and control may move from the (1,0) position to the (1,−0.3) position along the 0.6 Net Pedal curve. At this position, the COP value may be −0.3, calling for a reduction in the torque commanded of driven element 28. This reduction in torque may cause machine 10 to slow down until the COP value reaches zero, as visible in control moving generally leftward along the 0.6 Net Pedal Curve.

In a third example, assume that machine 10 is traveling at a previously desired speed and encounters an uphill grade. As the machine operator desires to continue at the same travel speed during the uphill grade, the operator keeps the right foot pedal 18b fully depressed and, thus, the Net Pedal value remains at 1 (referring to FIG. 5). However, as the machine traverses the grade, gravity may work against machine 10 and cause machine 10 to slow down, as visible in the generally leftward movement of control along the 1 Net Pedal curve. As the Actual Output Ratio of transmission unit 24 departs from the Desired Output Ratio Limit, the COP value may increase, resulting in an increasing torque commanded of driven element 28 that will function to maintain the travel speed of machine 10.

In a fourth example, assume that machine 10 is stopped in a pile (i.e., machine 10 is a wheel loader and has started to dig into a pile of earthen material) and the operator wishes to dig further into the pile. The speed of machine 10, Normalized Ratio, and COP value are all initially zero. As the operator depresses right foot pedal 18b, the Net Pedal value increases to, for example, 0.3. In this particular situation, the speed of machine 10 remains at zero and, thus, the Normalized Ratio remains zero. However, the COP value increases to 0.25 and subsequently the torque command directed to driven element 28 increases. As this increased torque does not yet satisfy the operator, the operator depresses right foot pedal 18b even more to about 0.6 and the COP value correspondingly increases to about 0.85. As the subsequently increased torque still does not satisfy the operator, the operator depresses right foot pedal 18b even more to about 0.8 and the COP value again increases to about 1, thereby further increasing the COT value and associated torque output command sent to driven element 28. In this manner, the operator may manage rimpull torque, even if the speed of machine 10 is unchanged.

Because the operating interface of transmission unit 24 may provide for torque control of a CVT, the operator of the associated machine may have better control over the performance of the machine, as compared to a speed controlled CVT. In particular, even if a speed of machine 10 does not change, the torque output may still be modulated by the operator. In addition, this modulation may be possible without inefficiently changing the operation of power source 22 or increasing control difficulty for the operator.

It will be apparent to those skilled in the art that various modifications and variations can be made to the disclosed operator interface. Other embodiments will be apparent to those skilled in the art from consideration of the specification and practice of the disclosed operator interface. It is intended that the specification and examples be considered as exemplary only, with a true scope being indicated by the following claims and their equivalents.

What is claimed is:

1. A continuously variable transmission, comprising:
a driven element;
a first operator input device;
a second operator input device; and
a controller configured to:
receive a first displacement signal associated with the first operator input device;
receive a second displacement signal associated with the second operator input device;
determine a net operator input value as a function of the first and second displacement signals; and
regulate an output of the driven element in response to the determined net operator input value.

2. The continuously variable transmission of claim 1, wherein at least one of the first and second operator input devices is a foot pedal.

3. The continuously variable transmission of claim 1, wherein the output of the driven element is regulated by commanding a torque of the driven device.

4. The continuously variable transmission of claim 3, wherein the driven element is an electric motor and the continuously variable transmission further includes a generator configured to power the electric motor.

5. The continuously variable transmission of claim 3, wherein the controller is further configured to:
receive an indication of desired transmission neutralization; and
command zero torque of the driven element in response to the indication.

6. The continuously variable transmission of claim 3, wherein the torque output is limited based on a travel speed.

7. The continuously variable transmission of claim 6, wherein the controller includes a limit map stored in a memory thereof, the limit map having a plurality of curves corresponding displacement positions of the second operator input device.

8. The continuously variable transmission of claim 1, wherein the controller is further configured to:
measure an actual transmission output;
determine a desired transmission output; and
determine an output command directed to the driven element based on the net operator input, the actual transmission output, and the desired transmission output.

9. The continuously variable transmission of claim 8, wherein the controller includes an output command map stored in the memory thereof, the output command map having a plurality of curves corresponding to different net operator inputs.

10. The continuously variable transmission of claim 8, wherein the actual transmission output is a ratio of a measured transmission input speed and a measured transmission output speed.

11. A machine, comprising:
a power source configured to generate a power output;
a traction device configured to propel the machine;
an operator station configured to receive input from the operator indicative of a desired machine movement; and
the continuously variable transmission as in claim 1 connected to transmit power from the power source to the traction device in response to the first and second displacement signals received via the operator station, wherein the driven element is an electric motor and the continuously variable transmission further includes a generator to power the electric motor.

12. A continuously variable transmission, comprising:
a driven element;
an operator input device; and
a controller configured to:
receive a displacement signal associated with the operator input device;
determine a desired output of the driven element;
determine an actual output of the driven element; and
directly regulate a torque output of the driven element in response to the displacement signal, the desired output, and the actual output.

13. The continuously variable transmission of claim 12, wherein the driven element is an electric motor and the continuously variable transmission further includes a generator configured to power the electric motor.

14. The continuously variable transmission of claim 12, wherein the torque output is limited based on a travel speed.

15. A machine, comprising:
a power source configured to generate a power output;
a traction device configured to propel the machine;
an operator station configured to receive input from the operator indicative of a desired machine movement; and
the continuously variable transmission as in claim 12 connected to transmit power from the power source to the traction device in response to the displacement signal received via the operator station, wherein the driven element is an electric motor and the continuously variable transmission further includes a generator to power the electric motor.

16. A method of transmitting power from an engine to a traction device, the method comprising:
receiving a first indication of a desired acceleration;
receiving a second indication of a desired deceleration;
determining a net indication value based on the first and second indications; and
directly controlling a torque directed to the traction device in response to the net indication value.

17. The method of claim 16, wherein directly controlling includes commanding a torque output of an electric device.

18. The method of claim 17, further including:
receiving an indication of desired neutralization of the traction device; and
commanding a zero torque output in response to the indication.

19. The method of claim 17, further including:
sensing a speed of the traction device;
sensing a speed of the power source;
determining an actual ratio of the power source speed and the traction device speed; and
normalizing the actual ratio with a desired ratio, wherein the commanded torque is determined based on the normalized actual ratio.

20. The method of claim 19, further including limiting the commanded torque based on the speed of the traction device.
